(19) United States
(12) Patent Application Publication
(10) Pub. No.: US 2019/0279457 A1
(43) Pub. Date: Sep. 12, 2019

(54) Hot and Cold Beverage Vending Machine with Manual Tap Dispensing System

(71) Applicants: Timothy Andrew Hoyt, Imperial Beach, CA (US); O'Neil Kumar Sawh, Temecula, CA (US); Mark William Hoyt, El Cajon, CA (US)

(72) Inventors: Timothy Andrew Hoyt, Imperial Beach, CA (US); O'Neil Kumar Sawh, Temecula, CA (US); Mark William Hoyt, El Cajon, CA (US)

(21) Appl. No.: 15/917,428

(22) Filed: Mar. 9, 2018

(51) Int. Cl. G07F 13/02; B67D 1/04; B67D 1/08

(52) U.S. Cl. CPC G07F 13/025; B67D 1/0406; B67D 2001/0092; B67D 1/0895; B67D 1/0857; B67D 1/0884

(57) ABSTRACT

A vending machine that dispenses hot or cold beverage liquid through standard beverage tap faucets into reusable or disposable beverage containers by manual manipulation of the tap faucet handles, which occurs as a result of the pressurized delivery of beverage liquid from pressurized beverage kegs or vessels through food-grade hoses, tubing or piping by use of nitrogen, carbon dioxide or other gas, that charges an individual a single amount for the total volume of beverage liquid dispensed based on a per unit (e.g., per ounce) price as displayed to said individual on a video (touchscreen) display as a running total in real-time fashion.

### CROSS REFERENCE TO RELATED APPLICATIONS

Not Applicable.

### BACKGROUND

The present claimed invention relates to the field of beverage vending.

Vending machines, especially beverage vending machines, have become a necessary staple of today's society with more than 7,000,000 vending machines in the United States alone. On average, more than $73,000,000 a year is spent by consumers at vending machines with more than 50% of all vending machines sales being generated from soda or cold drinks. However, while traditional beverage vending machine sales decline and technology advances, consumers continue to crave new and convenient methods of obtaining their beverages from vending machines.

### BRIEF SUMMARY

The present claimed invention comprises a custom vending chassis that fully encases a separate refrigeration unit situated in the lower section of the chassis that houses pressurized beverage kegs or vessels (“keg” or “kegs”) or is situated atop and affixed to a separate keg refrigeration unit not fully encased in the custom vending chassis. The upper section of the custom vending chassis contains a series of standard beverage tap faucets (commonly known and referred to as “tap” or “taps”) that deliver the beverage liquid from the refrigerated keg(s) to the customer once the tap handle(s) are manually pulled or manipulated by an individual or customer (“customer”). The foregoing process is managed by a software control and payment mechanism situated directly on the upper section of the vending chassis that instantaneously charges the customer a per unit (e.g., per ounce) price of the beverage liquid to be dispensed once payment is made via the cash, coin and/or card payment device and the customer pulls or manipulates the tap handles of the beverage taps.

Said invention allows the customer to purchase the designated beverage liquid(s) in desired (small or large) quantities while utilizing their own beverage containers or disposable beverage containers as provided in conjunction with the claimed invention, which provides the customer with a convenient and tailored beverage vending experience no traditional beverage vending machine currently offers.

### BRIEF DESCRIPTION OF THE DRAWINGS

FIG. 1 depicts an overview of the claimed invention in a front facing, angled view, which identifies the upper and lower sections of the custom vending chassis.

FIG. 1, 1a depicts the standard beverage tap faucets situated on the upper section of the claimed invention.

FIG. 1, 1b depicts the video touchscreen display situated on the upper section of the claimed invention.

FIG. 1, 1c depicts the cash, coin and/or card payment device situated on the upper section of the claimed invention.

FIG. 1, 1d depicts the tap handles affixed to the standard beverage tap faucets situated on the upper section of the claimed invention.

FIG. 2 depicts an overview of the upper section only of the custom vending chassis of the claimed invention.

FIG. 3 depicts a detailed view of the claimed invention with the doors of the custom vending chassis and refrigeration unit open to display the beverage kegs, the nitrogen, carbon dioxide or other gas tank and the tubing connected to the kegs and tank, which lead to the upper section of the custom vending chassis of the claimed invention and connect to the standard beverage tap faucets.

FIG. 3, 3a depicts the separate refrigeration unit situated within the lower section of custom vending chassis of the claimed invention.

FIG. 3, 3b depicts the beverage kegs contained within the refrigeration unit situated within the lower section of the custom vending chassis of the claimed invention.

FIG. 3, 3c depicts the nitrogen, carbon dioxide or other gas tank contained within the refrigeration unit situated within the lower section of the custom vending chassis of the claimed invention.

FIG. 3, 3d depicts the food-grade hoses, tubing or piping connecting the beverage kegs and the nitrogen, carbon dioxide or other gas tank to the tap faucets.

FIG. 4 depicts the rear, internal view of the upper section of the custom vending chassis of the claimed invention.

FIG. 4, 4a depicts the liquid heating device contained within the upper section of the custom vending chassis of the claimed invention.

FIG. 4, 4b depicts the software unit contained within the upper section of the custom vending chassis of the claimed invention.

FIG. 4, 4c depicts the solenoid-controlled valves contained within the upper section of the custom vending chassis of the claimed invention.

FIG. 4, 4d depicts the liquid flow meters contained within the upper section of the custom vending chassis of the claimed invention.

### DETAILED DESCRIPTION

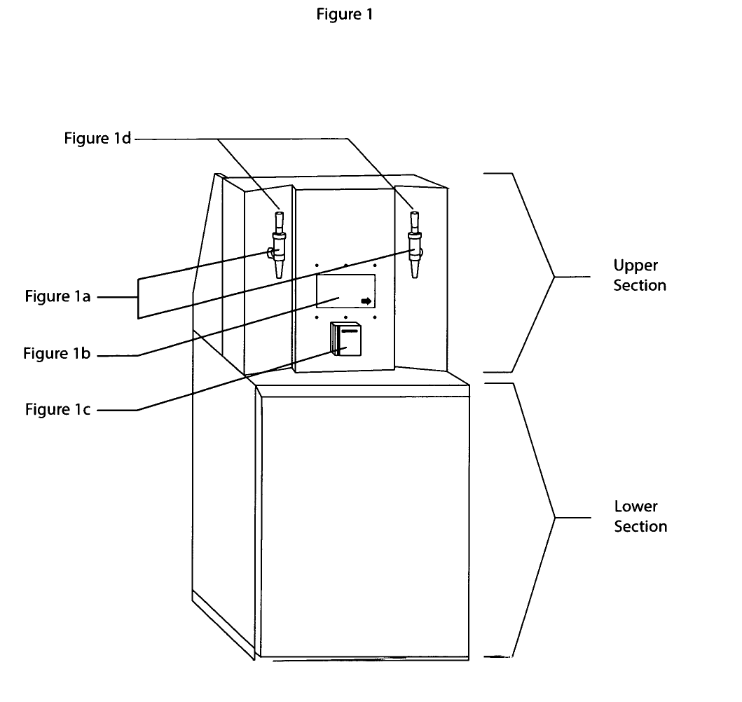

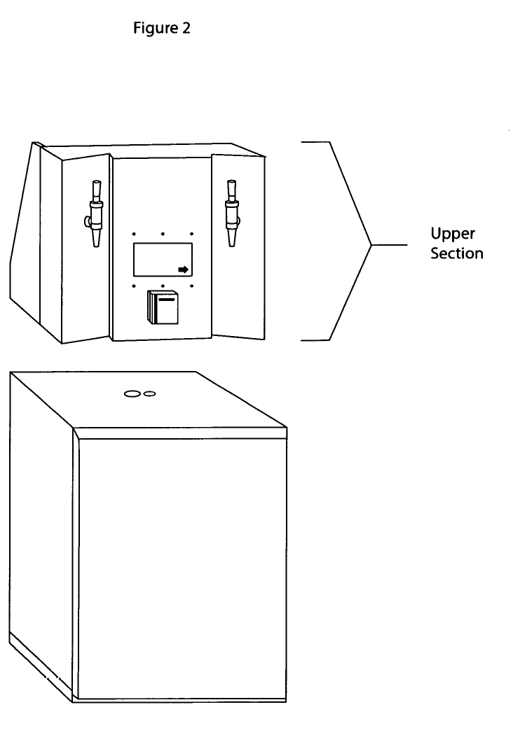

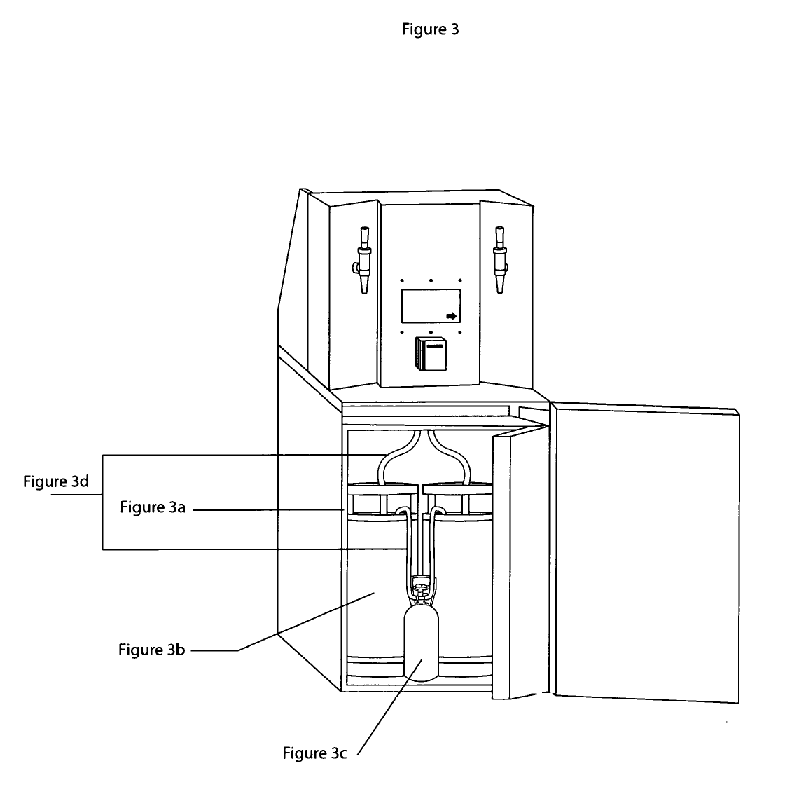

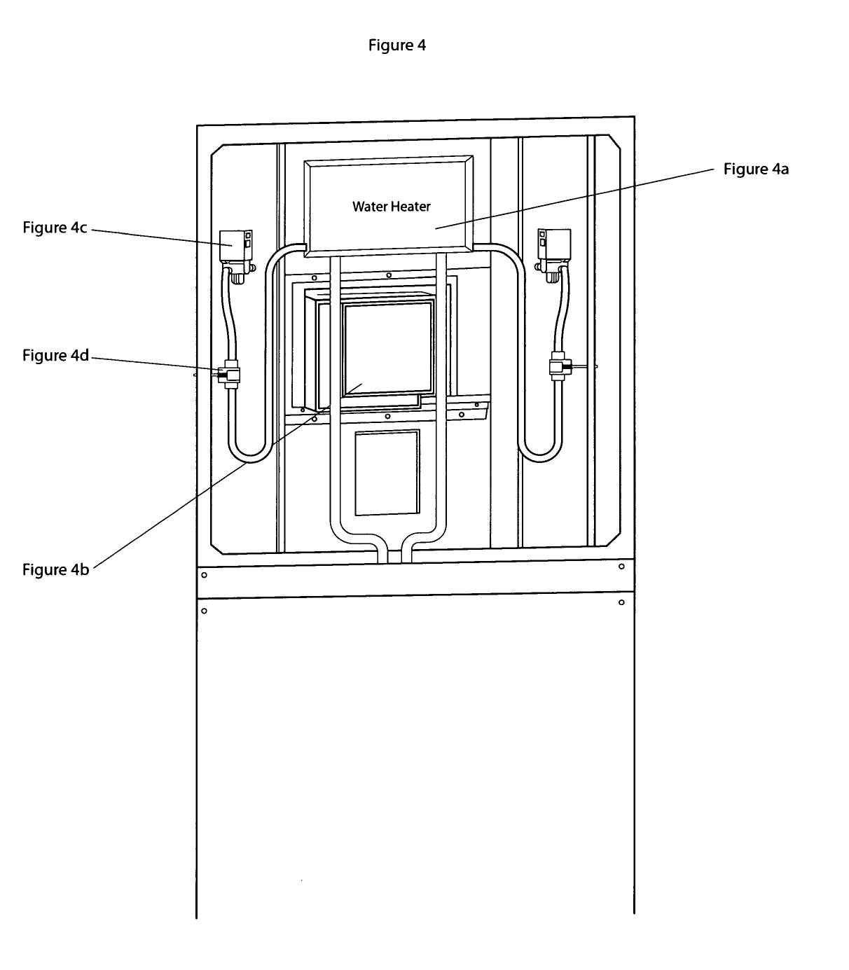

The present claimed invention comprises a custom vending chassis constructed of any commonly used industrial-grade metal, including, but not limited to steel or aluminum, that consists of an upper and lower section [FIG. 1] or an upper section only [FIG. 2]. The lower section, as embodied in FIGS. 1 and 3, fully encases a separate refrigeration unit that houses beverage kegs and a nitrogen, carbon dioxide or other gas tank(s). The separate refrigeration unit is designed to maintain the beverage kegs (and the nitrogen, carbon dioxide or other gas tank) at a cold, refrigerated temperature. The upper section of the vending chassis may also contain a liquid heating device [FIG. 4, 4a] used to heat the beverage liquid as described in the “Process of Use of Invention” contained within this disclosure. The upper section of the vending chassis, as embodied in FIG. 1, contains a series of standard beverage taps [FIG. 1, 1a], a video touchscreen display [FIG. 1, 1b] and a cash, coin and/or card payment device [FIG. 1, 1c].

### Process of Use of Invention

In one embodiment, as shown in FIG. 1, the claimed invention is designed as an unattended vending machine whereby a customer begins use of the invention by activating the standard payment device(s) affixed to the vending chassis [FIG. 1, 1c] by either swiping or inserting his or her credit, debit or other card, or by inserting a sufficient amount of valid currency (cash or coin) with the intent to purchase a certain volume of beverage liquid, as offered or available through the invention, according to a per unit (e.g. per ounce) price of beverage liquid as set by the owner or operator of the claimed invention. [The standard card payment device may also utilize Near-Field Communication (“NFC”) to accept payments via mobile phone or tablet devices. The foregoing action constitutes the beginning of a customer's transaction.

Pending authorization from the customer's credit, debit or other card provider (not applicable for cash or coin transactions), the invention's software unit [FIG. 4, 4b] sends an electronic signal to the solenoid-controlled valves [FIG. 4, 4c], which are connected to each tap, that opens each valve to allow for the flow of beverage liquid in anticipation of the customer's use of the tap(s).

Instructions are provided to the customer directly on the chassis of the invention and/or via the invention's video touchscreen display that direct the customer to select his or her desired beverage (as offered or available through the invention) and to pull or manipulate the tap handles [FIG. 1, 1d] to initiate the dispensing of said desired beverage.

The customer manually pulls or manipulates the tap handle(s) (or pushes an electronic button for accessibility or for individuals with disabilities) to initiate the dispensing of beverage liquid from the beverage kegs through food-grade hoses, tubing or piping (“tubing”) [FIG. 3, 3d] connected to the beverage kegs contained within the refrigeration unit, which is delivered by pressurized means utilizing nitrogen, carbon dioxide or other gas from the nitrogen, carbon dioxide or other gas tank(s) also contained within the refrigeration unit, thereby allowing the beverage liquid to be received by the customer in the customer's own beverage container(s) or within a disposable or non-disposable beverage container provided in conjunction with the invention.

As the beverage liquid is being dispensed through the invention and received by the customer, liquid flow meters [FIG. 4, 4d] coupled to the tubing track and measure the volume of beverage liquid (e.g., on a per ounce basis) being dispensed from the beverage kegs through the taps to the customer. Tracking and measuring of the volume of beverage liquid by the liquid flow meters occurs in real-time fashion, as read and received by the invention's software unit, and is simultaneously shown as a running total on the invention's video touchscreen display to be viewed by the customer in order for the customer to regulate his or her dispensing and purchase of volume of beverage liquid.

The customer also has the option of designating the temperature (hot or cold) of the beverage liquid to dispensed prior to pulling or manipulating the tap handle(s) of the tap(s), whereby the customer will be prompted by the invention's video touchscreen display to select whether he or she desires the beverage liquid to be dispensed “hot” or cold”, which will be represented by (virtual) buttons shown on the video touchscreen display that read “hot” or “cold”. If the customer desires the beverage liquid to be dispensed “cold”, the customer will press the “cold” button on the video touchscreen display and the process of use of the invention takes place as previously described. If the customer desires the beverage liquid to be dispensed “hot”, the customer will press the “hot” button on the video touchscreen display and the liquid heating device [FIG. 4, 4a] will instantaneously heat the beverage liquid as it is being dispensed to the customer. The exact temperature of the beverage liquid is determined by the temperature set on the keg refrigeration unit, for “cold” beverage liquid, and the temperature set at the liquid heating device, for “hot” beverage liquid, which are set by the owner or operator of the invention.

Upon receipt of the desired volume of beverage liquid (by the customer's termination of pulling or manipulating the tap handle(s)), the customer has the option of completing his or her transaction by pressing a (virtual) button shown on the invention's video touchscreen display that reads “Complete Transaction”. If the customer does not press said button within a designated amount of time (as set by the owner or operator of the invention), the invention's software unit will “time-out” and complete/close the customer's transaction unilaterally. The customer is then charged a single price for the total volume of beverage liquid dispensed through the invention (as tracked and measured by the liquid flow meters and the invention's software unit), which is calculated by the software unit based upon a per unit (e.g. per ounce) price of beverage liquid, as set by the owner or operator of the invention.

Similar to standard beverage vending machines common to the current vending machine market, the present claimed invention achieves the foregoing process of use in a completely unattended manner without human interaction or assistance. However, the present claimed invention is distinguishable from and unlike standard beverage vending machines because it offers customers the option and ability to obtain their hot or cold beverages in small or large quantities without being restricted to a pre-determined amount of beverage liquid or specific beverage container size. Prior to the present claimed invention, the typical beverage vending machines limited a customer to the quantity size of the beverage containers offered through said machines, when the customer may not desire that specific quantity of beverage liquid. The customer may desire more or less than the specific quantity of beverage liquid offered by way of said specific size beverage containers, which are only sold in fixed beverage quantities/amounts.

The present claimed invention allows the customer to manually and directly control the process and amount of beverage liquid dispensed, in real-time fashion, and further allows the customer to use his or her own, reusable beverage container(s). The customer's ability to use his or her own, reusable beverage container(s) offers an eco-friendly beverage container option that helps to reduce use and waste of disposable beverage containers that may be harmful to the environment.

What is claimed is:

1. An apparatus for dispensing hot or cold beverage liquid from standard beverage tap faucets (“taps”), comprising a refrigeration unit that houses and cools pressurized beverage kegs or vessels (“kegs”) and contains nitrogen, carbon dioxide or other gas tank(s) that includes a mechanism for cash, coin, card and/or Near-Field Communication (“NFC”) payment, and may include a liquid heating device for instantaneously heating of beverage liquid while dispensing said liquid.

2. The method from claim 1 of an individual being charged a single amount for the total volume of beverage liquid dispensed, per single transaction, based on a per unit (e.g., per ounce) price, as displayed to said individual on a video (touchscreen) display as a running total, in real-time fashion, once said individual manually pulls or manipulates handles affixed to the taps (or pushes button(s) near the taps) that causes beverage liquid to be dispensed from the taps into a reusable or disposable beverage container as a result of the pressurized delivery of said liquid from pressurized beverage kegs through food-grade hoses, tubing or piping by use of nitrogen, carbon dioxide or other gas.
